(19) United States
(12) Patent Application Publication
(10) Pub. No.: US 2024/0125024 A1
(43) Pub. Date: Apr. 18, 2024

(54) METHOD AND DEVICE FOR PRODUCING A NONWOVEN PRODUCT AND THE NONWOVEN PRODUCT SO PRODUCED

(71) Applicant: McAirlaid's Vliesstoffe GmbH, Steinfurt (DE)

(72) Inventor: Andreas SCHMIDT, Duderstadt (DE)

(21) Appl. No.: 18/378,389

(22) Filed: Oct. 10, 2023

(30) Foreign Application Priority Data
Oct. 18, 2022 (DE) 102022127320.2

(51) Int. Cl. D04H 1/732; D01D 5/42; D04H 1/425; D04H 1/50

(52) U.S. Cl. CPC D04H 1/732; D01D 5/423; D04H 1/425; D04H 1/50; D10B 2201/20

(57) ABSTRACT

A device and a method for producing a nonwoven product from fibres laid randomly in the air flow, especially cellulose fibres, and the resultant nonwoven product, in which a fibre material comprising fibres in bonded form is frayed in at least one mill and the resulting fibres are delivered in an air flow from the at least one mill to at least one depositing sieve and laid randomly on the at least one depositing sieve such that the nonwoven product is formed on the at least one depositing sieve, wherein a fibre material is broken down in a pre-shredding device into a pre-shredded fibre material deliverable in an air flow and there is provided a buffer storage to form a pre-shredded fibre material-stockpile from which pre-shredded fibre material is removed and delivered in an air flow to the at least one mill.

The invention relates to a method for producing a nonwoven product from fibres laid randomly in the air flow, especially cellulose fibres, in which a fibre material comprising fibres in bonded form is frayed in at least one mill and the resulting fibres are delivered in an air flow from the at least one mill to at least one depositing sieve and laid randomly on the at least one depositing sieve, such that the respective nonwoven product is formed on the respective depositing sieve.

The invention also relates to a device for producing a nonwoven product from fibres laid randomly in the airflow, especially cellulose fibres, comprising at least one mill, by means of which a fibre material comprising fibres in bonded form can be frayed, and at least one depositing sieve and at least one air flow duct through which the fibres formed with the mill can be delivered in an air flow from the at least one mill to the at least one depositing sieve, on which the fibres can be laid randomly, such that the respective nonwoven product can be formed on the respective depositing sieve.

One such method and one such device are known, e.g., from the publication EP 0 159 618 A1 of MIRA LANZA SPA.

The laying of fibres downstream from a mill in an air flow on a depositing sieve can be done in the prior art, as well as in the invention, by means of at least one so-called forming head, with which the fibres arriving in the air flow are distributed on the depositing sieve. Each depositing sieve—if several of them are being used at the same time—can be associated with at least one forming head for itself. An air flow with fibres being delivered in it can also be divided among multiple forming heads.

For example, a respective forming head in the prior art, as well as in the invention, can preferably comprise at least one mixing chamber, into which the air flow with the transported fibres is admitted.

In the mixing chamber there can be arranged, in the prior art as well as in the invention, at least one mixing apparatus, preferably in order to achieve a further homogenization of the fibre density or a further fibre singulation in the inner volume of the mixing chamber. Such a mixing apparatus can be formed, e.g., by at least one needle roller, which is driven in rotation in the mixing chamber.

A mixing chamber can also be configured as a rotating roller, the lateral surface of which has a plurality of passage openings, from which the fibres are taken in the direction of the depositing sieve. A forming head having such a mixing chamber is also called a drum former.

A forming head preferably has an exit, having at least one passage opening, preferably a plurality of passage openings, while the air with the transported fibres emerges from the exit in the direction of the depositing sieve.

The width of the exit can preferably be adapted to the width of the depositing sieve. Likewise, the cross section of the exit can generally be adapted to the shape of the depositing sieve.

A forming head can also itself comprise a stationary or movable depositing sieve, which filters out the fibres from the air flow; in particular, a forming head can also directly influence the shape of the nonwoven product to be produced. Thus, the forming head and the depositing sieve can form a common unit, or also separate units.

Thus, a forming head can be generally understood to mean a device which is provided to filter the fibres out from the air flow and place them in a predetermined form. Thus, for example, directly finished and contoured nonwoven products can be produced.

It is preferably provided according to the known prior art and preferably also according to the invention that the particular depositing sieve is stationary or movable. The depositing sieve can for example be transported continuously, preferably at uniform running speed, or it can be transported intermittently or also moved in reciprocating fashion. In one possible configuration, a depositing sieve can also be designed as a sieve conveyor belt, which can be moved intermittently, continuously, or in reciprocating fashion.

A depositing sieve can also be covered by a mask or form, in order to produce a nonwoven product contoured according to the mask or form.

With a mask or form or with an appropriately designed forming head it is possible to produce, e.g., directly contoured nonwoven products, e.g., for wound dressings, nappies, incontinency products, or female hygiene products.

Preferably, the laying of the fibres can be further supported in that a suction device is arranged on the side of the depositing sieve opposite the laying side, with which the oncoming air is suctioned, while the fibres are deposited on the laying side of the depositing sieve and form a fleece layer, which can form a nonwoven product directly or after further processing.

By virtue of the movement of the depositing sieve designed as a sieve conveyor belt during the laying of the fibres from the air flow thereon, a fleece web can be formed as the nonwoven product.

In general, a nonwoven product, especially a web-shaped nonwoven product, may be taken on for subsequent processing, e.g., a binding by means of calendering between two knobbed calendering rolls. A binding can also be accomplished by other techniques basically established in the prior art, such as latex bonding, thermobonding, mechanical compacting, and water jet needling.

In general, a depositing sieve can be understood as being an element which is permeable to air, but not to the fibres, at least not to the overwhelming majority of the fibres.

In order to achieve a constantly uniform quality, especially a uniform gram weight of the nonwoven product produced, especially a web-shaped nonwoven product, it must be ensured that the mass flow of fibres, especially that fed to a respective forming head, is likewise uniform.

This is accomplished in the prior art in that the starting fibre material to be frayed, comprising fibres in bonded form, is formed by an endless fibre material in the sense of production technology. Endless in this sense is a fibre material which in fact has an end, yet allows a predetermined, in particular sufficiently long and continuous production duration of the fleece production until the fibre material is changed.

Therefore, fleece manufacturers thus far have resorted in a known manner to a starting fibre material which is present as a web in roll form, so that the fibre material web can be unwound from such a roll and fed to the mill. This web can technically be referred to as endless, at least over the length of the rolled-up web, so that the fleece production can occur continuously or at least nearly continuously. The length of such a web is usually more than 100× longer than the width of the web.

Due to the actual length limitation, it is provided that the start of a new web is fed already to the entrance zone of a mill while another web is still being processed, especially frayed, it being provided to draw the start of the new web into the mill together with or immediately following the end of a previous web, so that no interruption of the nonwoven production need occur even between two webs.

In the field of fleece production from pulp, such rolled-up pulp webs are known as so-called fluff pulp that is produced by pulp suppliers specifically for fleece manufacturers in order to make possible such a necessary continuous production process.

The fraying of the fibre material web occurs in the prior art with so-called hammer mills or disc mills. Such mills have a plurality of rotating hammers or discs, to which the edge of the fibre material web is fed and by which fibres are unravelled from the assemblage of the web-shaped fibre material.

The problem with this procedure in the prior art is that the entire production process is oriented to the feeding of fibre material as a rolled-up web and other forms of fibre material with bonded fibres cannot be processed on account of the special process adaptation, even though many other forms of bonded fibres are available on the market.

Given this background, one object of the invention is to provide a method and a device for the production of nonwoven products which can be operated regardless of the starting form of the fibre material to be frayed, in particular also making possible the processing of fibre material not in web form.

According to the invention, this object is achieved in the method in that a fibre material, especially a starting fibre material, preferably an industrially produced starting fibre material, comprising bonded fibres, preferably pulp fibres, is broken down in a pre-shredding device into a pre-shredded fibre material deliverable in an air flow and the pre-shredded fibre material is transferred to a buffer storage to form a pre-shredded fibre material stockpile, wherein pre-shredded fibre material is removed from the pre-shredded fibre material stockpile so formed with at least one removal device, preferably multiple removal devices operated in parallel, and delivered in the air flow to the at least one mill.

According to the invention, the object is also achieved with a device of the kind mentioned at the outset, which furthermore comprises a pre-shredding device, with which a fibre material, especially a starting fibre material, preferably an industrially produced starting fibre material, comprising bonded fibres, can be broken down into a pre-shredded fibre material deliverable in an air flow, and comprising a buffer storage, to which the pre-shredded fibre material can be transferred to form a pre-shredded fibre material stockpile, and comprising at least one removal device, preferably multiple removal devices operated in parallel, by which pre-shredded fibre material can be removed from the fibre material stockpile, and comprising at least one air flow duct, by which the pre-shredded fibre material so removed can be delivered in the air flow to the at least one mill.

This procedure according to the invention affords the advantage of being able to use fibre material of any given starting form, in particular even when this starting form can no longer be referred to as endless or web-shaped in the sense described above.

The invention preferably achieves a transformation of a possibly non-continuous input of the original fibre material or starting fibre material in the production process to a needs-oriented, preferably at least substantially continuous, feeding of pre-shredded fibre material to a mill, which accomplishes the required fraying by inserting in the process chain, between the input of the original fibre material in the production process and the feeding of pre-shredded fibre material to the mill, a buffer storage, so that the possibility exists of feeding the fibre material to the buffer storage non-continuously, but also continuously, and in any case removing fibre material as needed, preferably at least substantially continuously, in order to feed the removed pre-shredded fibre material to the at least one mill.

Thus, with the invention it is possible to use in the process chain, next to a mill, even the devices which are established in the prior art, but also devices which are optimized for the invention.

“Fibre material” is understood to mean fibres which are bonded together, especially those not yet having attained a degree of fraying which is suitable for the laying in the air flow on a depositing sieve to form a nonwoven product. The starting fibre material or original fibre material which is used at the beginning in the invention and the pre-shredded fibre material formed from this in the buffer storage thus constitute fibre material in this sense.

Therefore, the fibre material pre-shredded with the pre-shredding device according to the invention is not yet considered to be frayed, and thus forms a kind of fibre cluster in which fibres are still bonded, the fibre cluster containing fewer fibres than the assemblage of the original fibre material but more than the fibres obtained after a mill. The pre-shredded fibre material thus forms an intermediate stage in the performance of the fraying, starting from the original fibre material or starting fibre material which is put into the method according to the invention and ending with the fibres which are laid in the air flow on the depositing sieve.

The invention can provide that a pre-shredding device is arranged vertically above the buffer storage, so that the pre-shredded fibre material falls by gravity into the buffer storage, e.g., in free fall or via a chute. In this way, no further conveying devices are needed between the pre-shredding device and the buffer storage. In any case, this procedure dictates a special spatial arrangement of the two units relative to each other.

The invention can also preferably provide that the pre-shredded fibre material is actively delivered from the outlet of the pre-shredding device to the buffer storage. This can be done, e.g., with a conveyor belt, onto which the pre-shredded fibre material drops.

Preferably, the transfer of the pre-shredded fibre material from the pre-shredding device to the buffer storage can also occur with an air flow, especially one which is guided in a flow duct—preferably as in all air flow applications of the invention.

The invention can provide achieving a cluster size of fibre material during the pre-shredding which can be delivered in free-floating fashion in the air flow. Preferably, in this case, the pre-shredded fibre material has a cluster size of less than 10 grams, preferably less than 5 grams. In such a configuration, the pre-shredding device and the buffer storage can also be situated spatially separate from each other.

The removal from the buffer storage occurs by means of at least one removal device, preferably at least substantially continuously. The achieved continuity, possibly differing from the ideal case, is preferably at least such that an equalization of the fibre mass flow is accomplished in the following process chain, which is suitable for achieving a uniform laying on the depositing sieve over time. Preferably, the fibre mass flow after a mill which is achieved according to the invention has a fluctuation of less than 15%, preferably less than 7%, further preferably less than 5%.

The invention also discloses the use of removal devices which basically provide a non-ideally continuous removal of pre-shredded fibre material from the buffer storage.

The invention can provide that a blending and thus homogenization of the fibre density in the forming head occurs in a forming head mentioned at the outset, which is also preferably used in the invention, on account of a dwell time of the fibres prior to leaving the forming head. It can thus be provided that the volume of the mixing chamber of the forming head is chosen in dependence on the removal device being used, especially its achieved quasi-continuity, thus preferably achieving thanks to the volume a nonwoven product having a gram weight fluctuation of preferably less than 15%, more preferably less than 7%, even more preferably less than 5%.

But the invention can also procedurally accomplish an equalization of the fibre mass flow upstream from the forming head. For this, for example, the respective individual removal with a removal device can be done fast enough, in particular to be below an aforementioned maximum fluctuation.

A required mass flow of fibre material can be controlled, e.g., through the removal amount per removal step. For this, the removal amount per removal step can preferably be adjustable, e.g., through a control or regulation system, especially in ongoing operation.

The invention can also provide for a parallel operation of multiple removal devices, especially such devices having a non-ideally continuous removal, considered individually. Preferably, the removal devices can be controlled so as to work with a phase shift among each other, especially such that the individual non-continuous delivery is at least substantially equalized over all the removal devices, preferably such that the aforementioned fluctuation in the fibre mass flow or the nonwoven product is not reached. Preferably, all of the removal devices controlled in this way deliver the removed pre-shredded fibre material to the same mill.

A removal device in one possible configuration can comprise, e.g., a cell wheel lock. Alternatively, a removal device can comprise an auger.

The invention can generally provide that the removal of pre-shredded fibre material from the buffer storage, or from its removal zone, is done volumetrically or gravimetrically, in particular is controlled or regulated with a control or regulation system. For example, the rotary speed or electric power of a removal device can be influenced as the control variable for achieving a given target value of the removal step.

The invention advantageously discloses that an endless web, especially a fluff pulp web unwound from a roll, can be used just as in the prior art as the fibre material which is originally put into the production process chain, especially fed to the pre-shredding device.

The fibre material can also generally be considered to be endless if it is n times longer than it is broad, e.g., with n>10, preferably n>100.

According to the invention, such a web is accordingly not fed directly to a mill, as in the prior art, but instead is fed at first to the pre-shredding device.

While at first this may appear unnecessary in view of the prior art, it turns out that the invention does not require the use of other original fibre materials, but instead the formerly used fibre materials can also continue to be used.

But the benefit of the invention becomes clear in that sheet goods, especially singulated sheets, preferably Kraft pulp sheets, can also preferably be used as fibre material. Such sheets can also be used when they have a production-related embossing, preferably because the form in which the fibre material is fed to the pre-shredding device is not important according to the invention.

In the prior art mentioned at the outset, for example, it is not possible to feed individual sheets to a hammer or disc mill, because the connection of successive sheets necessary for the continuity cannot be realized.

Thus, it is possible to also feed fibre material which is actually used for the wet production of paper.

It is especially advantageous that the invention also discloses the use of fibre material formed as block or bale goods, especially continuously bonded blocks or bales, preferably “flash dried pulp”, or fibre material formed as blocks or bales stacked from multiple sheets or a web wound up into a roll.

Thus, rolls and blocks or bales stacked from sheets need not be unrolled or pre-singulated when using the invention, but rather they can also be fed as a whole to the pre-shredding device according to the invention, the same as continuously bonded blocks or bales.

It is advantageous when the pre-shredding device is adapted or suited to processing and shredding such whole rolls, blocks or bales of fibre material.

In particular, it can be provided to design such a pre-shredding device as a shredder, especially one with counterrotating, preferably toothed rolls.

It is also possible to use as the pre-shredding device such devices with which fibre material is unravelled from the assemblage of a starting fibre material by milling or shredding, e.g., from blocks or bales, also including rolls.

The invention preferably provides that the fibre material, especially as entire block or bale goods, is fed non-continuously, especially by blocks or bales, to the pre-shredding device. An aforementioned roll also counts as a block here.

In this case, feeding intermissions can be provided between two consecutive fibre material blocks or bales according to the invention. For example, such intermissions can occur in that people are handling the blocks or bales and need to place them, for example, on a conveyor belt, which feeds the blocks or bales to the pre-shredding device. The intermissions can thus arise on account of the other labour required in connection with the handling of such blocks or bales, but they are immaterial according to the invention. Preferably, however, the pre-shredded fibre material will be removed at least substantially continuously from the buffer storage and be fed to the at least one mill.

The invention can provide that there will be supplied to the buffer storage, especially at least in a level-increasing phase, non-continuously or also continuously over a predetermined span of time, more fibre material than is removed, at least substantially continuously, from the buffer storage in the same span of time. It is thus ensured that the buffer storage does not run empty or overflow. Furthermore, according to the invention, it is not necessary to provide a uniformly distributed feeding of fibre material to the pre-shredding device over time, even though this is also possible. Thus, the buffer storage can run empty for example down to a minimum lower fill amount before needing to be filled once more. The filling can preferably be automated. For example, the fill amount or height in the buffer storage can be detected by measurement (e.g., optically, gravimetrically, etc.) and the feeding of starting fibre material can be controlled in dependence on a measurement value representing the fill amount or height. For example, the starting fibre material can be automatically removed from a material stockpile and fed to the pre-shredding device for this purpose.

The configuration of the buffer storage can preferably provide that this comprises an upper feed zone, which passes into at least one lower removal zone, preferably into multiple removal zones lying next to each other in parallel and extending preferably in the height direction, preferably vertically. The buffer storage can have a floor, e.g., having a number of removal zone openings corresponding to the number of removal zones. The respective removal zone opening can form the lower end of a funnel-shaped floor zone.

It can also be provided that a conveying system, especially a conveying system of rotating operation, is arranged in the buffer storage, especially on the floor, preferably above the at least one removal zone opening, with which pre-shredded fibre material is actively delivered in the direction of the at least one removal zone opening. Such a conveying system may comprise multiple conveying arms rotating about an axis. In particular, in such a case, a floor zone of a buffer storage can also be planar in configuration.

For example, it can be provided that the pre-shredded fibre material is compacted in a removal zone, e.g., at least compacted by force of gravity. This can be accomplished, e.g., in that additional pre-shredded fibre material arriving from above is placed on top of the fibre material located further down in the removal zone and brings about the compaction with the force of its weight.

Alternatively or additionally it can be provided to perform a compaction by means of at least one actuator provided in the removal zone. For example, such an actuator can be moved intermittently, e.g., as a kind of ram, preferably from the top down, into the removal zone and thus actively compact the pre-shredded fibre material located there, preferably in a downward direction.

A rotating worm can also be provided in the removal zone, performing a compaction in the direction of one of its ends, preferably in the direction of a lower end. In particular, in the case of an active compaction, the removal zone may also deviate in configuration from a vertical extension.

Thanks to the compaction, more pre-shredded fibre material is accommodated in the buffer, but it is preferably only compacted and not bonded once again, or in any case it is so loosely bonded after compaction that such a bonding is once again disrupted by the removal from the buffer storage or in the air flow.

The invention provides that the compacted pre-shredded fibre material is removed at the end, preferably the lower end, of the removal zone of the buffer storage by the removal device associated with the removal zone and is fed to an air flow, with which the transfer of the removed pre-shredded fibre material to the at least one mill occurs.

The invention can be used with different kinds of mills for the fraying of the pre-shredded fibre material.

For example, a hammer mill or also a disc mill with grinding segments can be used, being in particular actually designed to perform a fraying of fibre material at the edge of a fed web facing towards the mill. However, the applicant has found that the fibre material can also be fed to such mills in a pre-shredded form, preferably by an air flow.

Preferably for this purpose the pre-shredded fibre material is blown with the air flow through a flow duct emerging into the entrance zone of the mill upstream from the hammer or disc arrangement of the mill. Insofar as a fibre material bed of pre-shredded fibre material is formed there, the fibres are unravelled from the fibre material bed or, if this is not the case, from the pre-shredded fibre material by the hammers or discs. It can be provided to form an air bypass, with which the supplied air is routed around the mill, especially when a fibre material bed forms and impedes the air flow, especially in order to continue using the air for the delivery of the fibres freed up by the mill.

The invention thus discloses the use of the mills established in the prior art thus far, despite having a feeding process differing from the given type of operation.

Thus, production chains after the mills can also be configured according to the prior art, which simplifies the retrofitting of existing plants for the invention, since this can be done by including a buffer storage in the production chain upstream from the mill and only converting the mill feed to an air flow feed.

The invention can also provide for the use of an eddy current mill for the fraying of the pre-shredded fibre material.

Such an eddy current mill is based on the principle of creating a swirling of air in a mill housing, e.g., by a rotating rotor unit in a mill housing, and channeling the pre-shredded fibre material into the eddy, which becomes frayed by interaction with the rotor unit and by interaction with itself, i.e., the colliding of fibre clusters.

It can be provided in this case that the air flow by which pre-shredded fibre material is fed to the eddy current mill is also fed entirely through the eddy current mill and after this it is further used to deliver the freed-up fibres in the direction of the at least one forming head.

The invention can generally preferably provide that the air flow by which the pre-shredded fibre material is fed from the buffer storage to a mill is also utilized to take the fibres freed up by the mill to a forming head.

The feeding of pre-shredded fibre material to the eddy current mill can occur in this case radially near the rotor axis or at the radial centre, the fibres after the fraying of the pre-shredded fibre material being blown radially outwards from the housing of the eddy current mill.

It can be provided in this case that the air flow carrying the pre-shredded fibre material from the buffer storage to the eddy current mill is not fed through the latter, but instead the eddy current mill itself is also preferably operated or utilized as a conveying device for the air flow.

One possible configuration, especially in connection with an eddy current mill, but also with other kinds of mill, can provide that the air delivery flow with which fibres are delivered from the at least one mill to the sieve conveyor belt is greater than the air delivery flow with which pre-shredded fibre material is delivered from the buffer storage to the at least one mill.

For example, it can be provided for this purpose that a further air flow is added, especially upstream or downstream from the mill, to the air flow moving through the mill or moving past it and serving for the feeding of fibre material to the mill.

Such an increase in the air delivery flow may be necessary, e.g., when a very large nonwoven product width is to be produced, for which the air flow with which the pre-shredded fibre material is fed to the mill would not be sufficient.

In order to increase the air delivery flow (mass flow of air), it is possible to use e.g. an additional blower, with which an air flow is created and added, preferably downstream from the mill, to the air flow moving through the mill or moving past it.

Especially in connection with the use of an eddy current mill it can also be provided that this mill is used to increase the air delivery flow, especially by providing a suction opening at the inlet side of the eddy current mill, by which an additional air flow from the surroundings is further sucked in by the eddy current mill in addition to the air flow by which the pre-shredded fibre material is being fed, and both air flow components are accelerated through the eddy current mill. Thus, an air flow composed of both partial air flows is produced at the outlet side of the eddy current mill.

One development of the invention can provide that an operating parameter of the mill, especially an eddy current mill, is set or regulated such that speck-free fibres are produced, especially in dependence on the quantity of fibres delivered per unit of time and/or the type of fibre.

For this purpose, a measurement device can be provided advantageously, especially an optical measurement device, preferably for determining the number of specks per unit of surface or volume in the nonwoven product produced, and the operating parameter of the mill is adjusted in dependence on the measurement value of the measurement device.

The operating parameter can be, e.g., the rotary speed, the power, or a geometrical quantity of the mill, such as a mechanical gap spacing.

The invention can further provide that the nonwoven product produced is removed from the depositing sieve and taken through two surface-structured, preferably knobbed calendering rolls, wherein the fibres of the nonwoven product, preferably a web-shaped nonwoven product, are subjected to local pressure and bonded. Thus, the possibility exists of binding the nonwoven product in the thickness direction without binders. A binding of the nonwoven product can also be accomplished by other techniques basically known to the person skilled in the art.

The invention discloses in the mentioned embodiments the production of a nonwoven product from fibres, preferably cellulose fibres, by using any given form of the original fibre material and preferably from a fibre material originally not in web form, especially not unwound from the roll, but rather preferably the production of the nonwoven product from a fibre material in block or bale form, especially where a roll is also understood as being a block or bale.

Preferably an original fibre material (starting fibre material) made of pulp fibres and to be fed to the pre-shredding device is used in the invention. But other kinds of fibres of natural or synthetic origin can also be used in order to produce fleece webs from these kinds of fibres. For example, the invention also discloses the use of starting fibre material for the production of nonwoven products that is not industrially produced as web goods or as an “endless” web. For example, these are fibre materials of the following fibres: hemp, straw, bamboo, poplar, eucalyptus, Kraft pulp, but also banana, cacao, sisal, and so forth. Preferably, the invention can be used generally to form nonwoven products from the following fibres: Kraft pulp, hemp, or eucalyptus pulp.

Starting fibre material which is not produced as web goods or a web unwound from a roll is, to the knowledge of the applicant, only suitable in any other starting forms when using the method according to the invention for producing nonwoven products from it by laying the fibres in the air flow.

Embodiments of the invention shall be illustrated and explained with the aid of the figures.

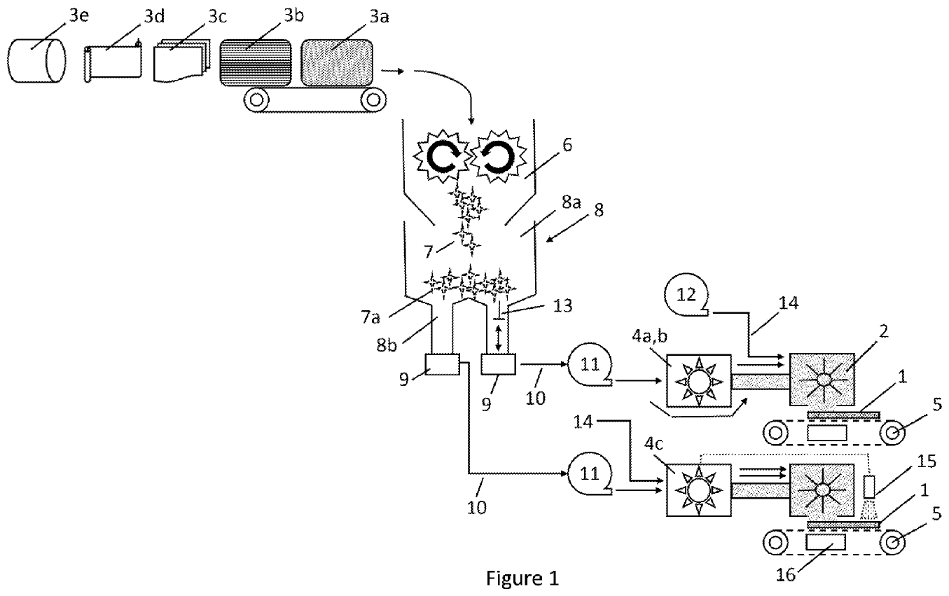

FIG. 1 shows a schematically simplified representation of the method according to the invention and the device employed for this.

Starting fibre material 3 according to the invention is fed in any desired shape or form to a pre-shredding device 6 in order to thus produce pre-shredded fibre material 7 which is not yet immediately suitable for laying as a nonwoven product in the air flow.

For example, the fibre material 3 may be present as a block or bale 3a, having continuously bonded fibres. For example, this may be flash-dried pulp. Alternatively, the fibre material may be present as a block 3b of stacked sheets, individual sheets 3c, an “endless” web 3d or also an entire roll 3e of a wound-up web. In fact, it makes no difference to the invention what kind of starting fibre material 3 is used.

The feeding of starting fibre material 3 to the pre-shredding device 6, which works for example as a shredder with counterrotating shredding shafts, can be done by means of a conveyor belt. The fibre material 3 can also be thrown manually directly into the pre-shredding device.

According to FIG. 1, the pre-shredded fibre material 7a solely by the action of gravity arrives in a buffer storage 8 through its upper zone 8a and enters there into multiple removal zones 8b at the lower end of the buffer storage 8. The pre-shredded fibre material 7a can be compacted and/or homogenized here by force of gravity or by an actuator 13.

In the buffer storage 8, a fibre material stockpile 7a of pre-shredded fibre material is formed according to the invention, which can be removed once more by removal devices 9 at the end of the removal zone 8b.

This removal is done preferably at least substantially continuously, e.g., by cell wheel locks or augers. By blowers 11, an air flow 10 can be created, with which the removed pre-shredded fibre material 7 is delivered to mills 4.

Mills 4 can be designed, e.g., as a hammer mill 4a or as a disc mill 4b, being actually designed to perform a fraying at one edge of a web, but also proving to be suitable for further fraying of fibre clusters delivered in the air flow 10.

The air flow 10 can pass through the mills 4a, 4b or also be taken past the mill 4a, 4b in a bypass, if a fibre bed is created in the mill 4a, 4b upstream from the hammers or discs and is hindering the air flow.

It can be provided here to add a further air flow 14 produced by a blower 12 downstream from the mill 4a, 4b to the air flow 10 which is feeding the pre-shredded fibre material 7 to the mill 4a, 4b.

When using an eddy current mill 4, the air flow 10 can likewise pass through the mill 4c and the eddy current mill itself can serve as a propulsion for the air flow and draw in a further air flow 14 from the surroundings—if needed—preferably at the inlet side.

From the mills 4, howsoever they are designed, the fibres 2 loosened from the fibre clusters 7 arrive through the air flow at forming heads and are laid by these on the depositing sieve 5, which can be designed e.g. as a circulating sieve conveyor belt, and in this way form the nonwoven product, especially a fleece web.

The laying from the air flow can be supported by a suction device 16, which draws in air at the side of the depositing sieve (the underside) opposite the laying side.

FIG. 1 shows as an example the use of an optical measurement device 15, for example, on the lower depositing sieve 5, with which the number of specks in the produced nonwoven product 1 can be detected. It can be provided to control the mill, e.g., its power or rotary speed, in dependence on the measurement value of the measurement device 15, in order to minimize the number of specks in this way, especially to produce speck-free fibres in the mill 4 and thus likewise produce speck-free nonwoven products 1.

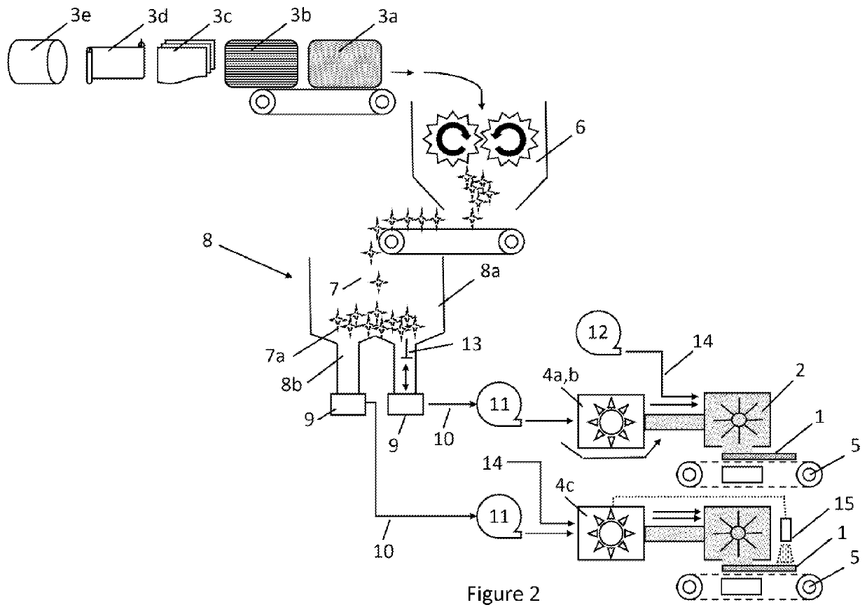

FIG. 2 shows an embodiment which only differs from the embodiment of FIG. 1 in that the delivery of pre-shredded fibre material 7 emerging from the pre-shredding device 6 is done actively, e.g., with a conveyor belt here.

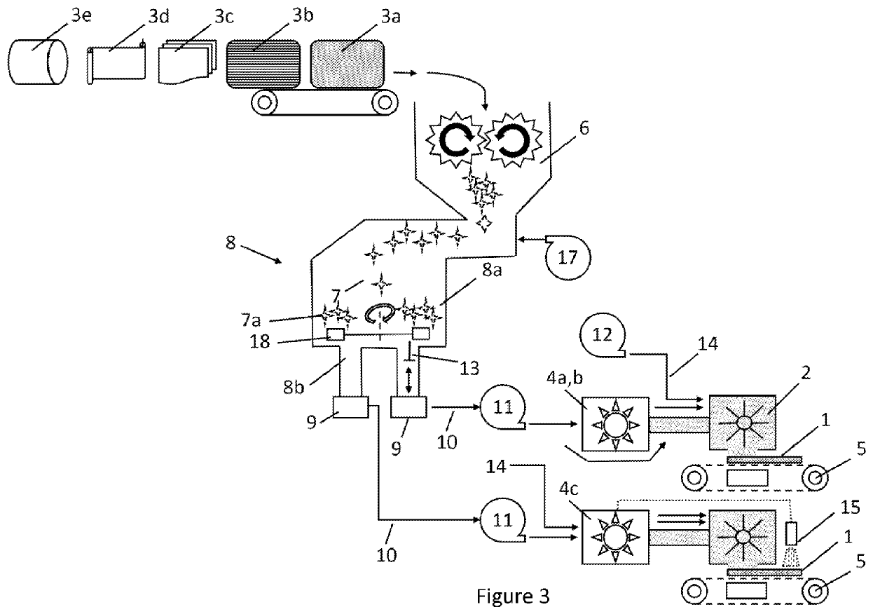

FIG. 3 shows an embodiment which differs from the embodiment of FIG. 1 in that the delivery of pre-shredded fibre material 7 emerging from the pre-shredding device 6 is done actively, e.g., with an air flow created by a blower 17 here. Furthermore, FIG. 3 shows an alternative embodiment of the buffer storage 8 having a conveying system 18 arranged on its floor with conveying arms driven to rotate about an axis of rotation in order to actively deliver the fibre material 7a to the removal zones 8b. The floor of the buffer storage 8 is planar here, as compared to the other embodiments.

All other statements for FIG. 1 also pertain to the embodiments of FIGS. 2 and 3.

1. A method for producing a nonwoven product from cellulose fibres laid randomly in an air flow, comprising fraying the cellulose fibres in bonded form in at least one mill and delivering the resulting fibres in an air flow from the at least one mill to at least one depositing sieve and laying the resulting fibres randomly on the at least one depositing sieve, such that the nonwoven product is formed on the at least one depositing sieve, wherein a cellulose fibre material is broken down in a pre-shredding device into a pre-shredded cellulose fibre material deliverable in an air flow and the pre-shredded cellulose fibre material is transferred to a buffer storage to form a pre-shredded cellulose fibre material stockpile, and wherein the pre-shredded cellulose fibre material is removed from the pre-shredded cellulose fibre material stockpile so formed with multiple removal devices operated in parallel, and delivered in the air flow to the at least one mill.

2. The method according to claim 1, wherein the cellulose fibre material is supplied to the pre-shredding device in one of the following configurations:
a. as a fluff pulp web unwound from a roll,
b. as singulated Kraft pulp sheets,
c. as continuously bonded blocks or bales comprising “flash dried pulp”, or as a block or bale made of multiple stacked sheets, or as a complete roll of a wound-up web.

3. The method according to claim 2, wherein the cellulose fibre material, as the block or bale goods, is fed non-continuously to the pre-shredding device with feed intermissions between two successive cellulose fibre material blocks or bales, and wherein the pre-shredded cellulose fibre material is removed from the buffer storage at least substantially continuously and fed to the at least one mill.

4. The method according to claim 3, wherein there is supplied to the buffer storage, at least in a level-increasing phase, non-continuously over a predetermined span of time, more pre-shredded cellulose fibre material than is at least substantially removed from the buffer storage in the same span of time.

5. The method according to claim 3, wherein the buffer storage comprises an upper feed zone which passes into multiple lower removal zones lying next to each other in parallel and extending vertically in a height direction, and wherein the pre-shredded cellulose fibre material is compacted in a removal zone at least by the force of gravity and/or by an actuator, and the compacted pre-shredded cellulose fibre material is removed at a lower end of the removal zone by a removal device associated with the removal zone and fed to an air flow by which transfer of the shredded cellulose fibre material so removed to the at least one mill occurs.

6. The method according to claim 1, wherein the at least one mill is one of the following:
d. a hammer mill;
e. a disc mill;
f. an eddy current mill.

7. The method according to claim 1, wherein the air delivery flow by which the cellulose fibres are delivered from the at least one mill to the at least one depositing sieve is greater than the air delivery flow by which the pre-shredded cellulose fibre material is delivered from the buffer to the at least one mill, for which purpose a further air flow is added, upstream or downstream from the mill, to the air flow moving through the mill or moving past the mill and serving for the feeding of the pre-shredded cellulose fibre material to the mill.

8. The method according to claim 7, wherein the mill is an eddy current mill and a rotary speed or power of the eddy current mill is set or regulated such that speck-free cellulose fibres are produced in dependence on the quantity of the cellulose fibres delivered per unit of time and/or the type of the cellulose fibres.

9. The method according to claim 8, wherein an optical measurement device for determining a number of specks per unit of surface or volume in the nonwoven product produced is provided, and wherein a rotary speed or power of the mill is set in dependence on a measurement value of the optical measurement device.

10. The method according to claim 1, wherein the nonwoven product produced is removed from the at least one depositing sieve and taken through two knobbed calendering rolls in which the cellulose fibres of the nonwoven product are subjected to local pressure and bonded.

11. A nonwoven product produced by the method according to claim 1, wherein the cellulose, preferably produced from a fibre material from which the non-woven fabric is produced is in block or bale form.

12. A device for producing a nonwoven product from cellulose fibres laid randomly in an air flow by the method according to claim 1, comprising
a. at least one mill configured to fray a fibre material comprising cellulose fibres in bonded form,
b. at least one depositing sieve and at least one air flow duct configured to deliver the cellulose fibres formed with the at least one mill in an air flow from the at least one mill to the at least one depositing sieve, the at least one depositing sieve being configured for the cellulose fibres to be laid thereon randomly to form the nonwoven product on the at least one depositing sieve,
wherein the device further comprises
c. a pre-shredding device configured to break down the cellulose fibre material into a pre-shredded cellulose fibre material configured to be deliverable in an air flow, and
d. a buffer storage configured for transfer thereto of the pre-shredded cellulose fibre material to form a pre-shredded cellulose fibre material stockpile, and
e. multiple removal devices configured to be operated in parallel to remove pre-shredded cellulose fibre material from the fibre material stockpile, and
f. at least one air flow duct configured to deliver the removed pre-shredded cellulose fibre material in the air flow to the at least one mill.
